(19) United States
(12) Patent Application Publication
(10) Pub. No.: US 2002/0114457 A1
(43) Pub. Date: Aug. 22, 2002

(54) LSI having interpreter function and information recording/reproducing apparatus using the same

(76) Inventors: Takahiro Sato, Osaka (JP); Hiroyuki Yabuno, Osaka (JP); Makoto Usui, Osaka (JP); Motoshi Ito, Osaka (JP)

Correspondence Address: Neil A. DuChez, Renner, Otto, Boisselle & Sklar, LLP, Nineteenth Floor, 1621 Euclid Avenue, Cleveland, OH, 44115, US

(21) Appl. No.: 10/051,585

(22) Filed: Jan. 18, 2002

(30) Foreign Application Priority Data
Jan. 26, 2001 (JP) 2001-18150

(51) Int. Cl. H04N 7/167

(52) U.S. Cl. 380/201

(57) ABSTRACT

An LSI comprises: a RAM for storing an intermediate code; a ROM for storing an interpreter execution program that is capable of interpreting the intermediate code; and a CPU for controlling execution of the interpreter execution program, wherein the RAM, the ROM, and the CPU are formed on one chip.

### BACKGROUND OF THE INVENTION

1. Field of the Invention

The present invention relates to an LSI having an interpreter function, and an information recording/reproducing apparatus using such an LSI. Specifically, the present invention relates to an LSI including a RAM for storing an intermediate code, a ROM for storing an interpreter execution program to interpret the intermediate code, and a CPU for controlling execution of the interpreter execution program, and an optical disc apparatus using such an LSI.

2. Description of the Related Art

In order to allow an LSI incorporating a CPU to perform its operation, it is necessary for the CPU to execute software (an execution program). In a conventional LSI, software used for performing its operation is previously stored in a memory such as a ROM or the like. When the LSI perform its operation, a CPU reads software from the ROM.

In the above conventional LSI, only software previously stored in the ROM can be executed, and it is not permitted to freely make a modification to software stored in the ROM. Thus, such an LSI cannot be used with various disc apparatuses available from a plurality of manufacturers, which are designed based on different standards and specifications. Furthermore, modifying specifications or adding functions, a need for which may arise in the process of development of a disc apparatus, cannot be readily satisfied. If such modification of specifications or addition of functions is achieved by adding an external ROM, there is a concern that the contents of the program (software) may leak during the operation of the LSI. Furthermore, there is a risk in that transmission of signals between the CPU and the ROM may be observed by a third party.

### SUMMARY OF THE INVENTION

According to one aspect of the present invention, an LSI comprises: a RAM for storing an intermediate code; a ROM for storing an interpreter execution program that is capable of interpreting the intermediate code; and a CPU for controlling execution of the interpreter execution program, wherein the RAM, the ROM, and the CPU are formed on one chip.

In one embodiment of the present invention, the intermediate code is encrypted.

In another embodiment of the present invention, the RAM can store an encrypted intermediate code and an unencrypted intermediate code; and the interpreter execution program can interpret both the encrypted intermediate code and the unencrypted intermediate code.

In still another embodiment of the present invention, the LSI further comprises: a recording/reproduction head for recording/reproducing information on an optical disc; and an optical disc control section for controlling a motor which drives the optical disc, wherein the optical disc control section is formed on the one chip.

According to another aspect of the present invention, an optical disc apparatus comprises: an execution section for executing an interpreter execution program that is capable of interpreting an intermediate code, so as to generate a control command string; and a control section for controlling recording/reproduction of information on an optical disc according to the control command string.

In one embodiment of the present invention, the execution section includes: a RAM for storing an intermediate code, a ROM for storing the interpreter execution program; and a CPU for controlling execution of the interpreter execution program.

In another embodiment of the present invention, the RAM, the ROM, and the CPU are formed on one chip.

In still another embodiment of the present invention, the control section includes a recording/reproduction head for recording/reproducing information on the optical disc; a motor for driving the optical disc; and an optical disc control section for controlling the recording/reproduction head and the motor.

In still another embodiment of the present invention, the optical disc control section is formed on the one chip.

In still another embodiment of the present invention, the intermediate code is encrypted.

In still another embodiment of the present invention, the RAM can store an encrypted intermediate code and an unencrypted intermediate code; and the interpreter execution program can interpret both the encrypted intermediate code and the unencrypted intermediate code.

Hereinafter, functions of the present invention will be described.

In an LSI according to the present invention, a RAM for storing an intermediate code, a ROM for storing an interpreter execution program capable of interpreting the intermediate code, and a CPU for controlling execution of the interpreter execution program are formed on one chip With such a structure, there is no concern of leakage of the contents of the interpreter execution program stored in the ROM outside of the chip during the operation of the CPU. Further, there is no possibility that transmission of signals between the CPU and the RAM and ROM is observed by a third party.

Furthermore, an optical disc apparatus of the present invention has an execution section for executing an interpreter execution program, which is capable of interpreting an intermediate code, so as to generate a control command string. With such a structure, the optical disc apparatus of the present invention can be modified only by rewriting the intermediate code so as to be compatible with various disc apparatuses from a plurality of manufacturers which are designed based on different standards or specifications. Furthermore, even when a necessity of modifying specifications or adding functions arises in the process of development of a disc apparatus, such necessity can be readily satisfied only by rewriting an intermediate code without adding additional circuitry to the LSI or exchanging the LSI itself with another one.

Thus, the invention described herein makes possible the advantages of: (1) providing an LSI which can be used with various disc apparatuses designed based on standards and specifications different among a plurality of manufacturers, in which a necessity of modifying specifications or adding functions which may arise in the process of development of a disc apparatus can be readily satisfied, and in which there is no concern that the contents of the program (software) may leak during the operation of the LSI; and (2) providing an optical disc apparatus using such an LSI.

These and other advantages of the present invention will become apparent to those skilled in the art upon reading and understanding the following detailed description with reference to the accompanying figures.

### BRIEF DESCRIPTION OF THE DRAWINGS

FIG. 1 shows an optical disc apparatus according to embodiment 1 of the present invention.

FIG. 2 shows a data structure of an intermediate code according to embodiment 1 of the present invention.

FIG. 3 illustrates a process for encrypting an intermediate code to generate an encrypted intermediate code according to embodiment 1 of the present invention.

FIG. 4 shows an example of a specific structure of an intermediate code according to embodiment 1 of the present invention.

FIG. 5 shows an exemplary structure of a specific cipher data according to embodiment 1 of the present invention.

FIG. 6 shows a structure of an encrypted intermediate code according to embodiment 1 of the present invention.

FIG. 7 shows a specific example of encrypted intermediate code data according to embodiment 1 of the present invention.

FIG. 8 illustrates a process for decrypting an encrypted intermediate code according to embodiment 1 of the present invention.

FIG. 9 illustrates a process for executing an intermediate code by an LSI according to embodiment 1 of the present invention.

FIG. 10 illustrates execution of an instruction of an intermediate code according to embodiment 1 of the present invention.

FIG. 11 shows an LSI according to embodiment 2 of the present invention.

FIG. 12 illustrates a process for executing an intermediate code according to embodiment 2 of the present invention.

### DESCRIPTION OF THE PREFERRED EMBODIMENTS

Hereinafter, embodiments of the present invention will be described with reference to the drawings.

An LSI of the present invention can be implemented as an LSI of any of the three types described below.

(First Type)

An LSI of the first type Includes a RAM for storing an intermediate code, a ROM for storing an interpreter execution program capable of interpreting the intermediate code, and a CPU for controlling execution of the interpreter execution program. The RAM, ROM and CPU are formed on one chip. In the LSI of the first type, the intermediate code store in the RAM is not encrypted. Thus, a user of the LSI of the first type can freely modify the intermediate code stored in the RAM so as to freely customize the LSI according to circumstances. For example, such an LSI can be commonly applied to apparatuses from different manufacturers only by modifying the intermediate code. Even when a necessity of modifying specifications or adding functions arises in the LSI, the user does not need to add additional circuitry to the LSI or exchange the LSI itself with another one, but only needs to modify the intermediate code stored in the RAM. Thus, the time and cost which are spent for developing a product incorporating the LSI can be considerably reduced.

(Second Type)

An LSI of the second type includes a RAM for storing an intermediate code, a ROM for storing an interpreter execution program capable of interpreting the intermediate code, and a CPU for controlling execution of the interpreter execution program. The RAM, ROM and CPU are formed on one chip. This structure is the same as that of the LSI of the first type. However, the LSI of the second type is different from the LSI of the first type in that the intermediate code is encrypted. Thus, when a necessity of modifying specifications or adding functions arises in the LSI of the second type, a user of the LSI can freely customize the LSI by requesting a vender of the LSI to modify the intermediate code stored in the RAM. Therefore, the user does not need to add additional circuitry to the LSI or exchange the LSI itself with another one. Thus, the time and cost which are spent for developing a product incorporating the LSI can be considerably reduced. Furthermore, encryption of the intermediate code is beneficial to the vendor of the LSI in that the know-how of device control can be kept secret from the user.

(Third Type)

An LSI of the third type includes a RAM for storing an intermediate code, a ROM for storing an interpreter execution program capable of interpreting the intermediate code, and a CPU for controlling execution of the interpreter execution program. The RAM, ROM and CPU are formed on one chip. This structure is the same as those of the LSIs of the first and second types. However, the LSI of the third type is different from the LSIs of the first and second types in that the intermediate codes stored in the RAM include encrypted intermediate codes and unencrypted intermediate codes, and the interpreter execution program can interpret both the encrypted intermediate codes and unencrypted intermediate codes. Thus, when a necessity of modifying specifications or adding functions arises in the LSI of the third type, a user of the LSI can freely customize the LSI according to circumstances by modifying the unencrypted intermediate codes stored in the RAM. The user does not need to add additional circuitry to the LSI or exchange the LSI itself with another one, but only needs to modify the unencrypted intermediate codes stored in the RAM. Thus, the time and cost spent for developing a product incorporating the LSI can be considerably reduced. Further, since the user cannot interpret the encrypted intermediate code, the vendor of the LSI is safe in knowing that the know-how of device control will not become open to the user. In the LSI of the third type, the user uses a decryption key net by the vendor (e.g., any consecutive random portion of the data stored in the ROM) in order to decrypt the encrypted intermediate code. It is preferable that different decryption keys are allocated to different users, so that information can be kept secret among the users. In this way, in the LSI of the third type, convenience for the user and the benefit to the vendor can be concomitantly achieved.

Next, a method for executing an encrypted intermediate code stored in the RAM of the LSI (of the above second or third type) of the present invention is described.

When the LSI of the present invention executes an encrypted intermediate code stored in the RAM under the control of the CPU by using the interpreter execution program stored in the ROM, the following two method can be employed. In this first method, previously encrypted intermediate codes stored in the RAM are decrypted, and the decrypted intermediate codes are sequentially executed for each instruction. In this second method, the RAM has an externally-accessible region and an externally-inaccessible region. First, a previously-encrypted intermediate code recorded in the externally-accessible RAM region is decrypted, and the decrypted intermediate code is executed after having been recorded in the externally-inaccessible RAM region.

Hereinafter, embodiment 1 which relates to an optical disc apparatus with an LSI having an interpreter function of the first execution method, and embodiment 2 which relates to an optical disc apparatus with an LSI having an interpreter function of the second execution method, are described in this order with reference to the drawing. It should be noted that the embodiments described below are merely exemplifications of the present invention, but the present invention is not limited to such exemplary embodiments.

(Embodiment 1)

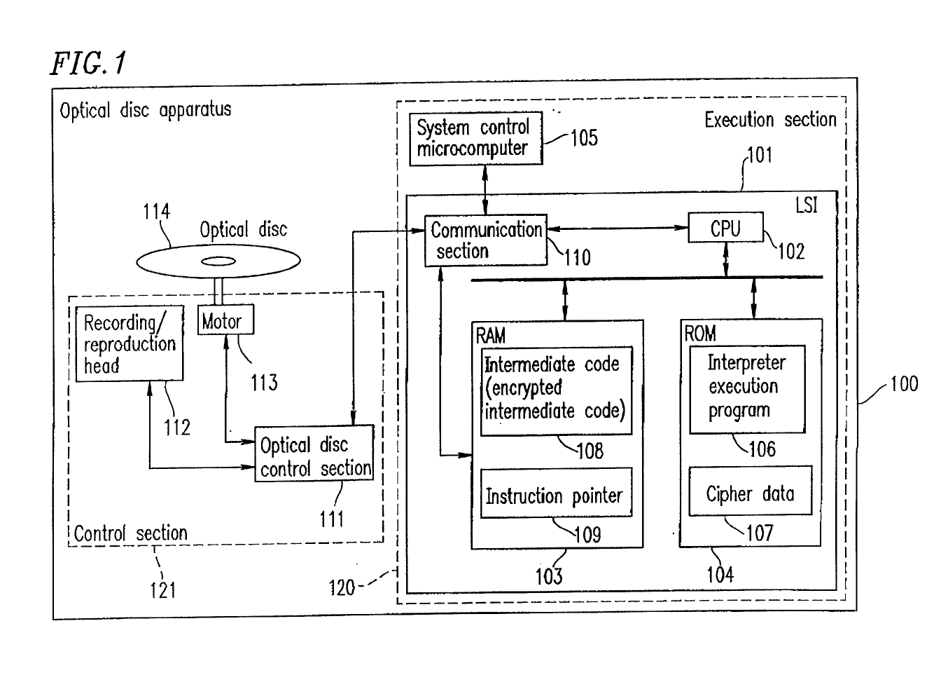

FIG. 1 shows an optical disc apparatus 100 according to embodiment 1 of the present invention.

The optical disc apparatus 100 includes an execution section 120 for executing an interpreter execution program 106, which is capable of interpreting an intermediate code 108, so as to generate a control command string, and a control section 121 for controlling recording/reproduction of information on an optical disc 114 according to the generated control command string.

The execution means 120 includes a RAM 103 for storing the intermediate code 108, a ROM 104 for storing the interpreter execution program 106 which is capable of interpreting the intermediate code 108, and a CPU 102 for controlling execution of the interpreter execution program 106. The RAM 103, ROM 104, and CPU 102 are formed on one chip, which functions as a LSI 101. Furthermore, the execution means 120 may include a system control microcomputer 105 for controlling the entire optical disc apparatus 100. The LSI 101 may include a communication section 110. In this case, the communication section 110 can establish communication with the control section 121, the system control microcomputer 105, the CPU 102, and the RAM 103. The RAM 103 may include, in addition to the intermediate code 108, an instruction pointer 109 which indicates an address of the intermediate code 108. Alternatively, a register or memory (not shown) provided in the CPU 102 may be used as an instruction pointer. The ROM 104 may include, in addition to the interpreter execution program 106, cipher data 107 which is used for decrypting the intermediate code 108. In this case, among the data in the ROM 104, any consecutive data in an address region, which can be considered as substantially random data, can be used as the cipher data 107.

The control section 121 includes, a recording/reproduction head 112 for recording/reproducing information on the optical disc 114, a motor 113 for driving an optical disc, and an optical disc control section 111 for controlling the recording/reproduction head 112 and the motor 113. The optical disc control section 111 may be formed in the LSI 101, i.e., may be formed together with the RAM 103, ROM 104, and CPU 102 on one chip.

Next, an operation of the optical disc apparatus according to embodiment 1 is described. As described above with classification of the first, second, and third types of LSIs, an intermediate code to be executed by the interpreter execution program may include an unencrypted intermediate code, an encrypted intermediate code, or both unencrypted and encrypted intermediate codes. Herein, the following descriptions are made in conjunction with an encrypted intermediate code. In the case of using or partially using an unencrypted intermediate code, a process for encoding an encrypted intermediate code is omitted from an operation of the optical disc apparatus, but the other processes are substantially the same as those performed in the operation of an optical disc apparatus which uses an encrypted intermediate code.

First, intermediate code produced by an intermediate code developer is previously encrypted to obtain an encrypted intermediate code 108. Next, the intermediate code 108 is stored in the RAM 103 provided in the LSI 101 by using the system control microcomputer 105. When an interpreter execution instruction is issued by the system control microcomputer 105, the CPU 102 in the LSI 101 executes the interpreter execution program 106 stored in the ROM 104. Then, the CPU 102 interprets and executes the intermediate code 108 while decrypting the intermediate code 108 stored in the RAM 103 by using the cipher data 107 stored in the ROM 104. Subsequently, the CPU 102 uses the communication section 110 to set a command parameter in a register provided in the optical disc control section 111, to issue a command to the optical disc control section 111, and to acquire the status of the optical disc control section 111, whereby the optical disc control section 111 is controlled.

Next, an intermediate code executed by the interpreter execution program is described in more detail.

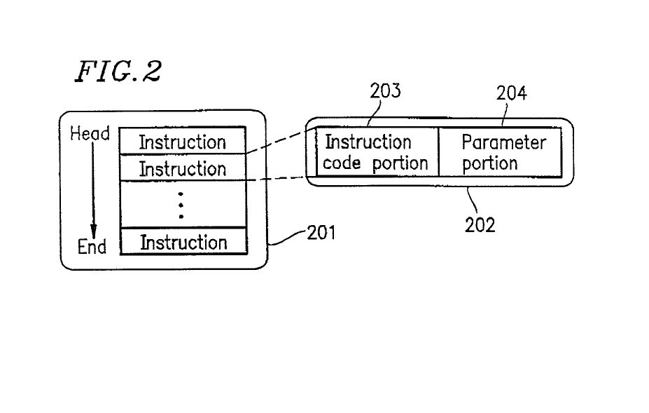

FIG. 2 shows a data structure of an intermediate code 201 according to embodiment 1 of the present invention.

The intermediate code 201 includes at least one instruction 202. In the example illustrated in FIG. 2, the intermediate code 201 includes a plurality of instructions 202. The instructions 202 are arranged from the head to end of the intermediate code 201 to form a series of instructions, which functions as a control command string associated with control of the optical disc apparatus. Each instruction 202 includes an instruction code portion 203 of a 1 byte length which indicates the type of the instruction, and a parameter portion 204 which is used as an argument of the instruction and which has a length of 0 or more bytes. The length of the parameter portion 204 is different in each instruction. The interpreter execution program 106 interprets at least one instruction 202 included in the intermediate code 201 by units of one instruction, and executes the interpreted instruction.

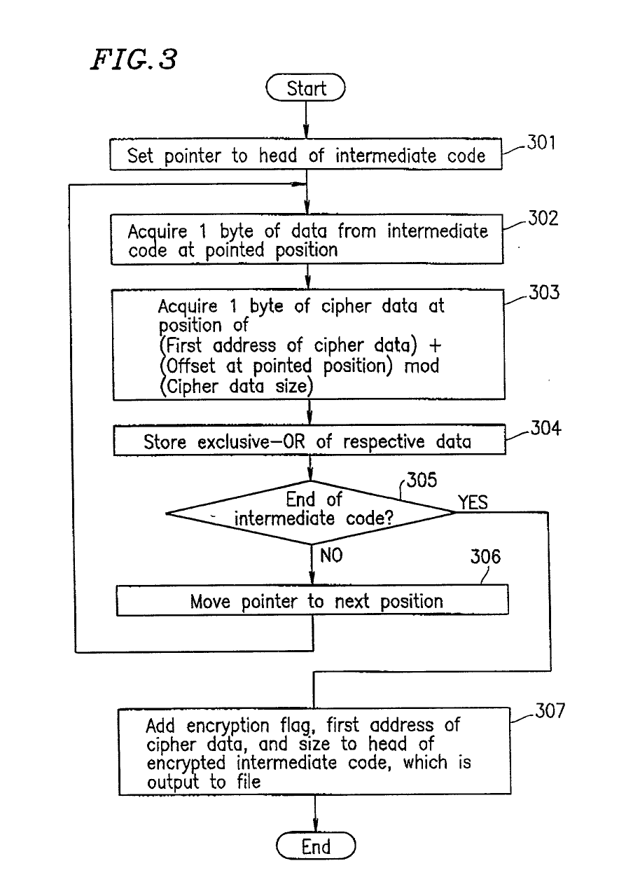

FIG. 3 illustrates a process for encrypting an intermediate code to generate an encrypted intermediate code according to embodiment 1 of the present invention. This encryption process is performed prior to a process for storing an intermediate code in the RAM 103. Encryption of an intermediate code may be performed on a personal computer by using a program.

An unencrypted intermediate code is subjected to the processes from step 301 to step 307 so as to be encrypted into an encrypted intermediate code 108. At step 301, a pointer is set at the head of an intermediate code. At step 302, 1 byte of data is acquired from the intermediate code at the pointer position. Next, at step 303, 1 byte of cipher data is acquired from an address specified by adding, to the first address of the cipher data 107, the remainder of an offset between the first address and a position of the intermediate code which is pointed by the pointer with respect to the size of the cipher data. Then, at step 304, a result obtained from an exclusive-OR of the obtained 1 byte portion of the intermediate code and the obtained 1 byte portion of the cipher data is stored in a memory as encrypted data. Next, at step 305, it is determined whether or not a current pointer position is at the end of the intermediate code. If the current pointer position is not at the end of the intermediate code, the pointer is moved to a next position at step 306, and then, the encryption process is repeated again from step 302. If the current pointer position is at the end of the intermediate code, the process proceeds to step 307. At step 307, at the head of the encrypted intermediate code string, 1 byte of data, 0×01, which functions as an encryption flag indicating that the intermediate code has been encrypted, the first address of the cipher data 107 on the ROM, and the size of the cipher data 107 are attached. The encrypted intermediate code with such information attached is output to a file, and then, the encryption process terminates. Herein, “0×” means that the data is represented by a hexadecimal number.

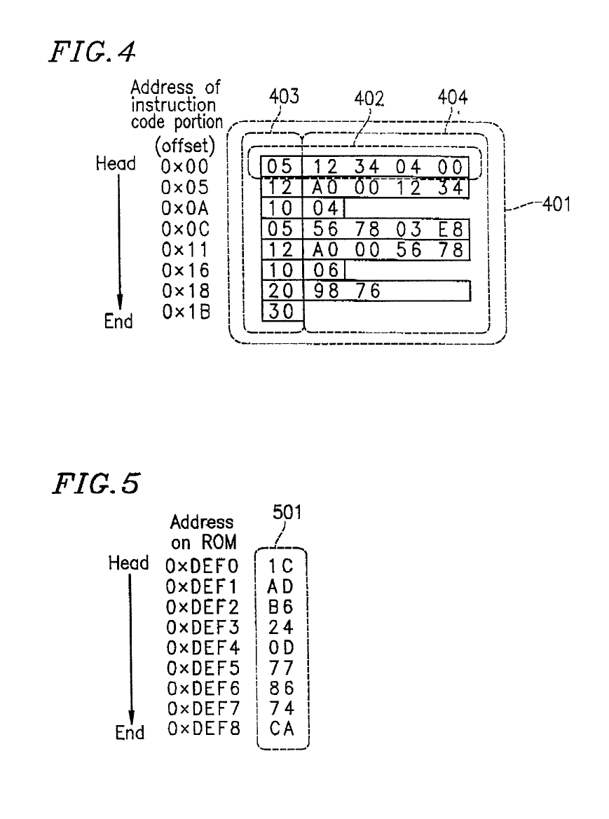

Next, a procedure for encrypting an intermediate code is specifically described with reference to FIGS. 4 and 5.

FIG. 4 shows an example of a specific structure of an intermediate code according to embodiment 1 of the present invention.

FIG. 4 shows an intermediate code 401, an instruction 402, an instruction code portion 403, and a parameter portion 404. In FIG. 4, an immediate write instruction (0×05) given to the memory, an optical disc control command issuance instruction (0×10) given to the optical disc control section, a parameter setting instruction (0×12) given to the optical disc control section, a status acquisition instruction (0×20) for an optical disc control instruction, and a termination instruction (0×30) are shown as instruction code portions. Details of each instruction 402 are described below.

The immediate write instruction (0×05) given to the memory is an instruction to write 2 bytes of immediate data in the memory. The intermediate code 401 includes an instruction to write immediate data 0×0400 in address 0×1234 of the memory, and an instruction to write immediate data 0×03E8 in address 0×5678 of the memory.

The optical disc control command issuance instruction (0×10) given to the optical disc control section is an instruction to issue a command for controlling the optical disc control section. Based on this instruction, an optical disc control command corresponding to a command code in the parameter section is issued using as an argument a value written in address 0×A000 in a parameter register of the optical disc control section. The intermediate code 401 includes an instruction to issue a motor ON command for rotating an optical disc (command code: 0×04) and an instruction to issue a laser ON command for performing recording/reproduction of information on an optical disc (command code: 0×06).

The parameter setting instruction given to the optical disc control section is an instruction to copy a value of the memory into a register of the optical disc control section. The intermediate code 401 includes an instruction to copy a value of address 0×1234 in the memory into address 0×A000 in the register, and an instruction to copy a value of address 0×5678 in the memory into address 0×A000 in the register.

The status acquisition instruction for an optical disc control instruction is an instruction to copy into the memory a status which indicates a terminated state of an instruction, which is returned from the optical disc control section after the optical disc control instruction terminate. The intermediate code 401 includes an instruction to copy the status in address 0×9876 into the memory.

The termination instruction is an instruction to terminate the execution of the intermediate code 401.

Summarizing the above, when the intermediate code 401 of FIG. 4 is executed, the LSI of the present invention performs the following processes. First, immediate data 0×0400 is written in address 0×1234 of the memory, and the value written in address 0×1234 is copied to address 0×A000 of the register in the optical disc control section. Then, a command to rotate the motor for rotating the optical disc is issued to the optical disc control section by using as an argument the value in address 0×A000 of the register in the optical disc control section. Then, immediate data 0×03E8 is written in address 0×5678 of the memory, and the value written in address 0×5678 is copied to address 0×A000 of the register in the optical disc control section. Then, a command to turn on a laser for recording/reproducing information on the optical disc is issued to the optical disc control section by using as an argument the value in address 0×A000 of the register in the optical disc control section. Then, the status of the above commands is copied into address 0×9876 of the memory, and thereafter, the execution of the intermediate code 401 terminates.

FIG. 5 shows an exemplary structure of a specific cipher data according to embodiment 1 of the present invention.

FIG. 5 shows a specific cipher data 501, which is recorded in consecutive address regions from the first address on the ROM 104, 0×DEF0.

Hereinafter, as an example, a process of encrypting the intermediate code 401 of FIG. 4 using the cipher data 501 of FIG. 5 is described in conjunction with the process of encrypting the intermediate code shown in FIG. 3 to generate an encrypted intermediate code.

At step 301 in FIG. 3, a pointer is set at an address in which an offset from the head of the intermediate code 401 is 0×00. At Step 302, data 0×05 is acquired from the intermediate code 401 at the pointer position. At step 303, since (0×DEF0)+(0×00)mod(0×09)=0×DEF0, cipher data 0×1C which is at address 0×DEF0 on the ROM is acquired. Then, at step 304, a result obtained from an exclusive-OR of data 0×05 obtained from the intermediate code 401 and cipher data 0×1C, i.e., result 0×19, is stored in the memory as encrypted data. Next, at step 305, it is determined whether or not the current pointer position is at the end of intermediate code 401. Since the address of offset 0×00 is not at the end of intermediate code 401, the pointer is moved to a next position at step 306, and the process returns to step 302. Encryption of the intermediate code 401 is achieved by further performing the processes of step 302 to step 306. The processes of step 302 to step 306 are repeated until the end of the intermediate code 401 is detected. The repeated processes are the same as those described above, and thus, detailed descriptions thereof are omitted. Now, the procedure performed after the pointer is moved to the end of the intermediate code 401, i.e., offset 0×1B, is described.

After the pointer has reached the end of the intermediate code 401, at step 302, data 0×30 is acquired from the intermediate code 401 at the pointer position. At step 303, since (0×DEF0)+(0×1B)mod(0×09)=0×DEF0, cipher data 0×1C which is at address 0×DEF0 on the ROM is acquired. Then, at step 304, a result obtained from an exclusive-OR of data 0×30 obtained from the intermediate code 401 and cipher data 0×1C, i.e., result 0×2C, is stored in the memory as encrypted data. Next, at step 305, it is determined whether or not the current pointer position is at the end of intermediate code 401. Since the address of offset 0×1B is at the end of intermediate code 401, the process proceeds to step 307. At step 307, encryption flag 0×01, the first address of the cipher data 501 on the ROM, 0×DEF0, and the size of the cipher data 501, 0×0009, are added at the head of the encrypted intermediate data. The encrypted intermediate data with such information is output to a file, and the process terminates.

Next, a structure of the intermediate code which has been encrypted in the above-illustrated manner is described.

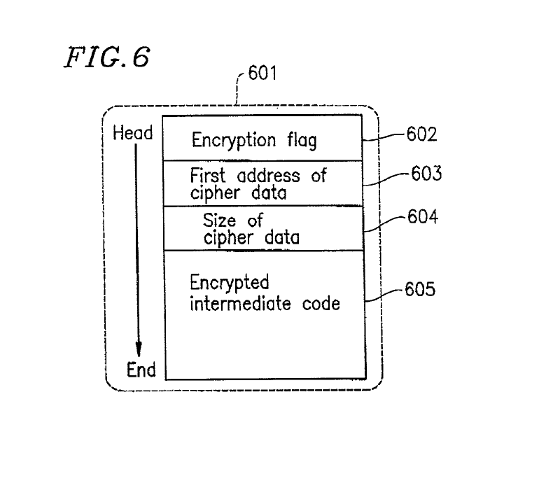

FIG. 6 shows a structure of an encrypted intermediate code according to embodiment 1 of the present invention.

Encrypted intermediate code data 601, which is obtained by adding encryption information to an encrypted intermediate code, includes an encryption flag 602 having a length of 1 byte, a first address 603 of a cipher data on the ROM which has a length of 2 byte, a cipher data size 604, and an encrypted intermediate code 605. If the intermediate code is encrypted, data 0×01 is recorded as the encryption flag 602, and if the intermediate code is not encrypted, data 0×00 is recorded as the encryption flag 602. By decrypting the encrypted intermediate code 605, an original intermediate code can be obtained.

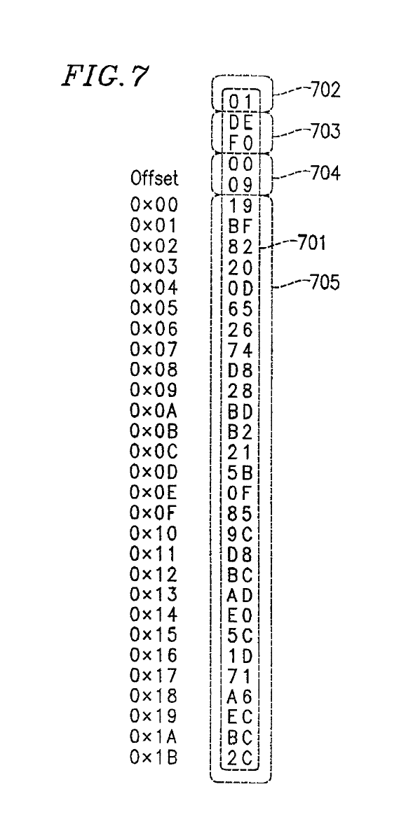

FIG. 7 shows a specific example of encrypted intermediate code data according to embodiment 1 of the present invention. The encrypted intermediate code data 701 of FIG. 7 can be obtained by encrypting the intermediate code 401 of FIG. 4 using the cipher data 501 of FIG. 5. The encrypted intermediate code data 701 includes an encryption flag 702, a first address 703 of the cipher data on the ROM which is used for encrypting the intermediate code 701, a cipher data size 704, and the encrypted intermediate code 705. The encrypted intermediate code data 701 is downloaded to the RAM 103 by the system control microcomputer 105 so as to be executed.

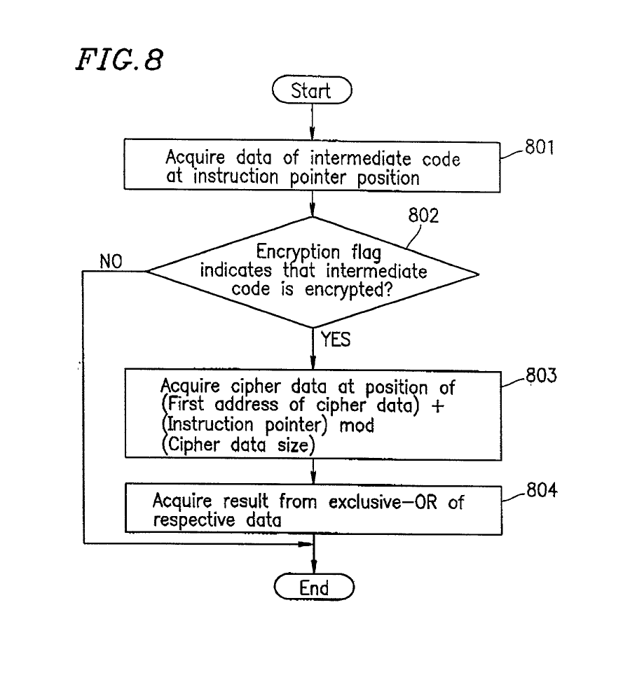

FIG. 8 illustrates a process for decrypting an encrypted intermediate code according to embodiment 1 of the present invention.

Decryption of an encrypted intermediate code is achieved by performing the processes of step 801 to step 804. At step 801, 1 byte of data is acquired from the intermediate code at the position of an instruction pointer. At step 802, it is determined whether or not the intermediate code has been encrypted by referring to the value of the encryption flag (e.g., the encryption flag 602 shown in FIG. 6). Specifically, if the encryption flag is 0×00 at step 802, the intermediate code is not encrypted, and then, the process terminates. If the encryption flag is 0×01 at step 802, the process proceeds to step 803. At step 803, 1 byte of cipher data is acquired from an address specified by adding the remainder of the offset pointed by the pointer from the first address of the intermediate code with respect to the cipher data size to the first address of the cipher data. At step 804, decryption is performed by using an exclusive-OR of the obtained 1 byte of intermediate code and a 1 byte of cipher data, and a result of the decryption is acquired to terminate the process.

Now, in order to describe more specifically the process of FIG. 8 for decrypting the encrypted intermediate code, a process of decrypting the encrypted intermediate code data 701 of FIG. 7 using the cipher data 501 of FIG. 5 is described. A process of decrypting data in an address of offset 0×08 in the encrypted intermediate code data 701 of FIG. 7 is described as an example.

At step 801 of FIG. 8, data 0×D8 is acquired from the intermediate code at pointer position 0×08. At step 802, it is determined whether or not the encryption flag indicates that the intermediate code has been encrypted. In the encrypted intermediate code data 701, it is determined that it has been encrypted, because the value of the encryption flag 702 is 0×01, and the process proceeds to step 803. At step 803, since (0×DEF0)+(0×08)mod(0×09)=0×DEF8, cipher data CA is acquired from address 0×DEF8 on the ROM. Then, at step 804, decryption data 0×12 is obtained from an exclusive-OR of data 0×D8 from the intermediate code and cipher data 0×CA. The value of the decryption data 0×12 is equal to the value of offset 0×08 of an address in the intermediate code 401 of FIG. 4.

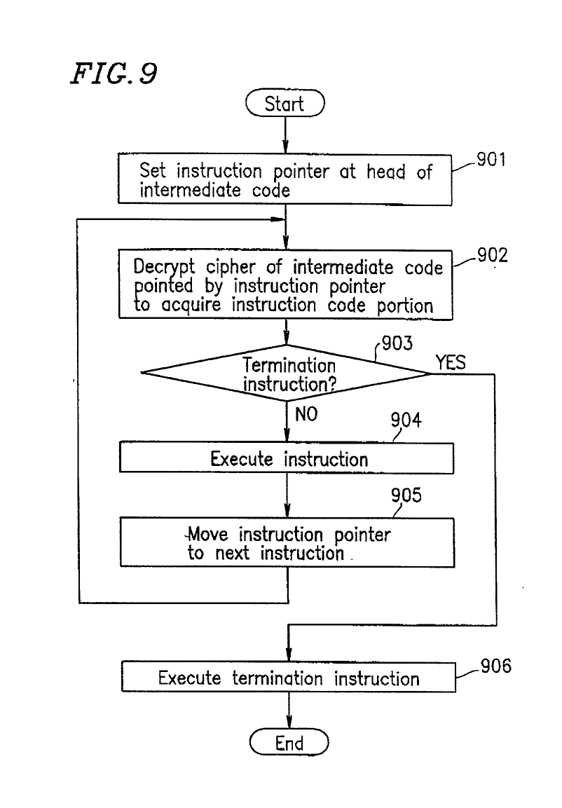

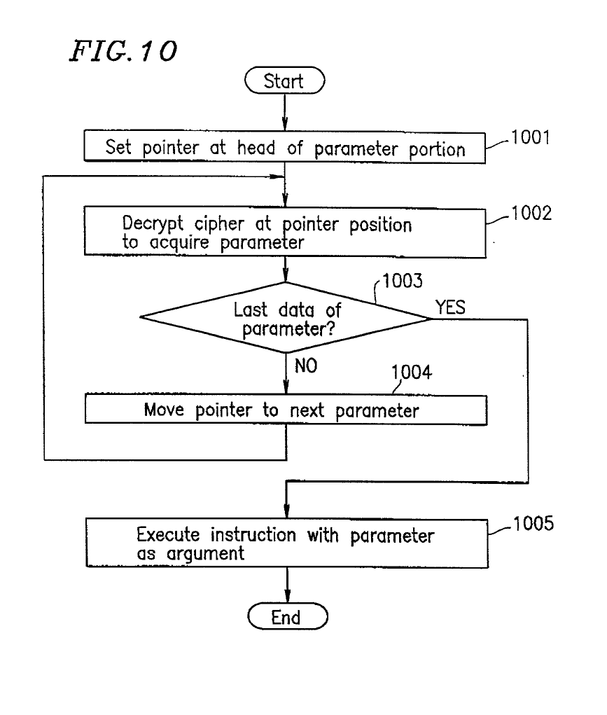

FIG. 9. illustrates a process for executing an intermediate code by an LSI according to embodiment 1 of the present invention.

The LSI of the present invention downloads encrypted intermediate code data obtained by the process of FIG. 3 to the RAM 103 using the system control microcomputer 105. Then, the LSI sequentially decrypts the encrypted intermediate code data stored in the RAM 103 for each instruction through the decryption process of FIG. 8, and executes the decrypted intermediate code. Execution of the intermediate code is achieved by the processes of step 901 to step 906. At step 901, the instruction pointer is set at the head of the intermediate code. Next, at step 902, a cipher is decrypted through the procedure of FIG. 8 to acquire an instruction code portion of the intermediate code. At step 903, it is determined whether or not the instruction code portion of the intermediate code obtained at step 902 is a termination instruction. If it is not the instruction code portion of the intermediate code, the instruction is executed at step 904. Thereafter, the instruction pointer is moved to a next position at step 905, and the process returns to step 902 again. At step 903, it is determined that the instruction code portion of the intermediate code is a termination instruction, the process proceeds to step 906. At step 906, the termination instruction is executed, and the execution of the interpreter is terminated.

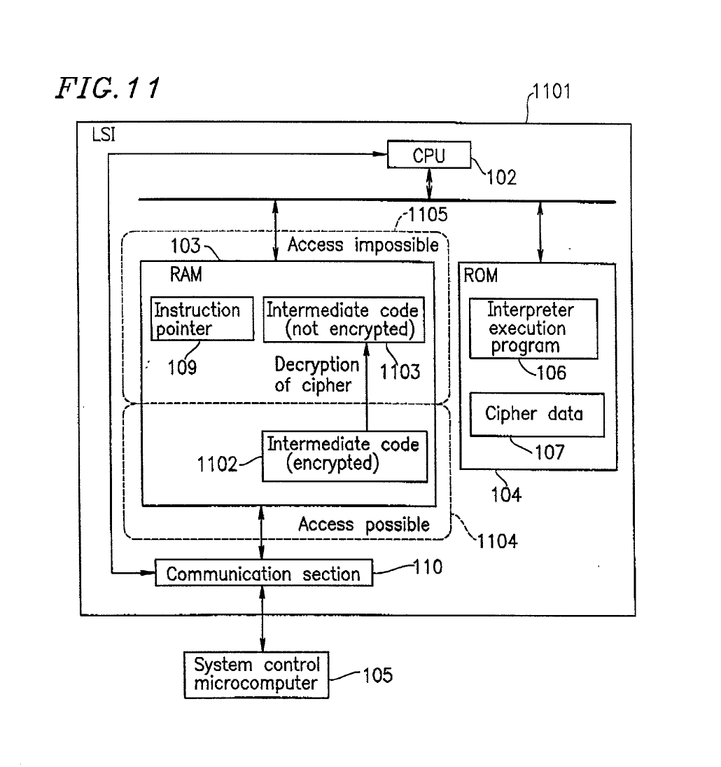

Execution of an instruction at step 904 is achieved by decrypting a cipher through the process of FIG. 10 to obtain a parameter portion of the intermediate code.

FIG. 10 illustrates execution of an instruction of an intermediate code according to embodiment 1 of the present invention.

Execution of an instruction at step 904 is achieved by performing the operations of step 1001 to step 1005 of FIG. 10. At step 1001, a pointer is set at the head of a parameter portion of a intermediate code instruction. At step 1002, a cipher of a parameter at a position of the pointer is decrypted so as to obtain a parameter having a length of 1 byte. Decryption of this cipher is achieved by the process for decrypting an encrypted intermediate code of FIG. 8. Next, at step 1003, it is determined whether or not the parameter at the pointer position is the last parameter. If the parameter at the pointer position is not the last parameter, the pointer is moved to a next position at step 1004, and the process returns to step 1002 again. If the parameter at the pointer position is the last parameter, the process proceeds to step 1005, and an instruction is executed using the parameter obtained at step 1002 as an argument. Thereafter, the decryption process terminates.

Hereinafter, execution of an instruction based on an interpreter execution program, which is performed in the processes of FIGS. 9 and 10, is specifically described. In the exemplary process described herein, the encrypted intermediate code data 701 of FIG. 7 is decrypted using the cipher data 501 of FIG. 5, and the decrypted intermediate code is actually executed. In this example, the intermediate code data 701 has been previously downloaded to the RAM 103 by the system control microcomputer 105.

At step 901 of FIG. 9, the instruction pointer is set at a position of offset 0×00 of the first address of the encrypted intermediate code 705. Next, at step 902, data 0×19 at the position of the instruction pointer in the encrypted intermediate code 705 is decrypted according to the process of FIG. 8 so as to obtain data of the instruction code portion, i.e., data 0×05. At step 903, it is determined whether or not the instruction code portion of the intermediate code acquired at step 902 is a termination instruction. The value of the instruction code portion is 0×05, i.e., it is not the termination instruction, and therefore, the process proceeds to step 904. Details of the process at step 904 for executing an instruction are described later. Next, at step 905, the instruction pointer is moved to a next offset 0×04, and the process returns to step 902 again. Since the size of the parameter is determined for each instruction, an offset for the next instruction can be obtained even when the intermediate code is encrypted. The operations of step 902 to step 905 are repeated for each instruction in the same manner as described above, whereby execution of the intermediate code is performed. The operations of step 902 to step 905 are repeated until the termination instruction is detected at step 903, and therefore, detailed descriptions of these repeated operations are herein omitted. If the offset of an address pointed by the instruction pointer is 0×1B, an instruction code portion obtained by decrypting a cipher at step 902 is 0×30. In this case, at step 903, it is determined that the instruction code portion of the intermediate code is the termination instruction. Thus, the process proceeds to step 906. After the termination instruction has been executed at step 906, execution of the intermediate code is terminated.

Execution of an instruction of the intermediate code at step 904 is described according to the process illustrated in FIG. 10 for executing an instruction of the intermediate code. In the example illustrated herein, an instruction pointer is set at offset 0×00 of an address.

At step 1001 of FIG. 10, a pointer is set at offset 0×01 of the first address of a parameter portion of an instruction pointed by the instruction pointer. At step 1002, data 0×BF of offset 0×01 of the address pointed by the pointer is decrypted so as to obtain data 0×12 of the parameter portion. Then, at step 1003, it is determined whether or not data acquired at step 1002 is the last data of the parameter, Since data 0×12 is not the last data, the process proceeds to step 1004. At step 1004, the pointer is set at offset 0×02 of an address of data of the next parameter portion, and the process proceeds to step 1002. Thereafter, the operations of step 1002 to step 1004 are repeated in the same manner as described above so as to obtain data of the parameter portion, 0×34, 0×04, and 0×00. When the pointer points at offset 0×04 of an address, it is determined at step 1003 that offset 0×04 is the last data, and then, the process proceeds to step 1005. At step 1005, values 0×12, 0×34, 0×04, and 0×00 obtained in the above process are used as parameter portions to execute an instruction of instruction code portion 0×05, and thereafter, the process is terminated. Specifically, since the instruction of instruction code portion 0×05 is an instruction to write immediate data having a size of 2 bytes in the memory, immediate value 0×0400 is written in address 0×1234 of the memory, and the process is terminated.

With the above structures and arrangements, according to an LSI of the present invention, a RAM for storing an intermediate code, a ROM for storing an interpreter execution program capable of interpreting the intermediate code, and a CPU for controlling execution of the interpreter execution program are formed on one chip. Therefore, there is no concern that the contents of the interpreter execution program stored in the ROM leak outside during the operation of the CPU. Furthermore, there is no possibility that transmission of signals between the CPU and the RAM and ROM is observed by a third party.

Further, an optical disc apparatus of the present invention has an execution section for executing an interpreter execution program, which is capable of interpreting an intermediate code, so as to generate a control command string. Thus, the optical disc apparatus of the present invention can be modified only by rewriting an intermediate code portion without replacing the LSI with another one, so as to be compatible with various disc apparatuses from a plurality of manufacturers which are designed based on different standards or specifications. Furthermore, even when a necessity of modifying specifications or adding functions arises in the process of development of a disc apparatus, such necessity can be readily satisfied only by rewriting an intermediate code without adding additional circuitry to the LSI or exchanging the LSI itself with another one. Furthermore, even when the LSI of the present invention is supplied to a third party user other than a developer(s), the know-how of control of an optical disc apparatus can be kept secret from the third party user by encrypting an intermediate code, although the other portions of the intermediate cord, i.e., unencrypted portions of the intermediate code, can be freely customized by the third party user. Thus, protection of the source of profit for the manufacturer and convenience for users can be concomitantly achieved.

(Embodiment 2)

Next, an LSI according to embodiment 2 of the present invention and an optical disc apparatus using the LSI are described.

FIG. 11 shows an LSI 1101 according to embodiment 2 of the present invention. The structure of the LSI 1101 according to embodiment 2 is substantially the same as that of the LSI 101 used in the optical disc apparatus 100 according to embodiment 1. Like elements are indicated by like reference numerals used in embodiment 1, and detailed descriptions thereof are omitted.

In the LSI 1101 of embodiment 2, a RAM 103 has an accessible RAM region 1104 which is accessible from a system control microcomputer 105, and an inaccessible RAM region 1105 which is not accessible from the system control microcomputer 105. In embodiment 2, a previously-encrypted intermediate code 1102 is stored in the accessible RAM region 1104, and the encrypted intermediate code 1102 is decrypted in the first step. The decrypted intermediate code is stored in the inaccessible RAM region 1105 as a decrypted intermediate code 1103, and the decrypted intermediate code 1103 is executed using an interpreter execution program 106. In embodiment 2, the accessible RAM region 1104 and the inaccessible RAM region 1105 are formed on the same memory, but they may be formed on different memories.

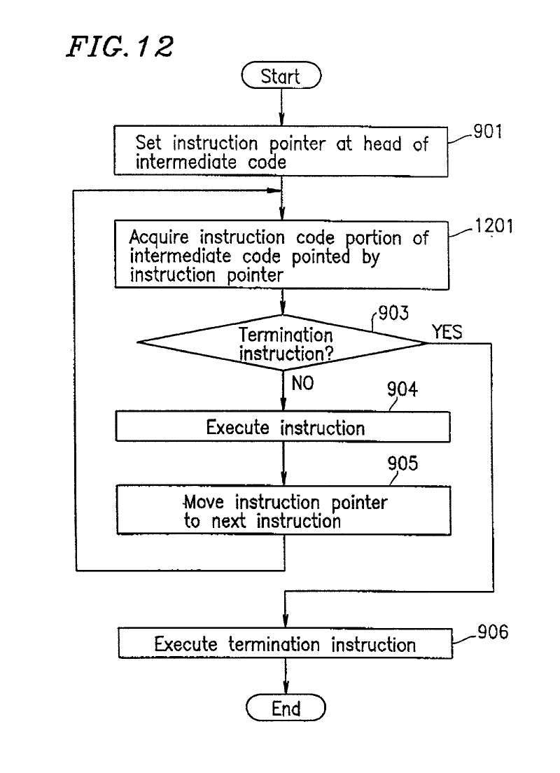

Encryption and decryption of an intermediate code are performed in accordance with the processes of embodiment 1 shown in FIGS. 3 and 8, respectively. Alternatively, encryption and decryption of an intermediate code can be achieved using a known encryption algorithm, such as a RSA algorithm, a DES algorithm, or the like. A procedure for executing an intermediate code using an interpreter execution program according to embodiment 2 is illustrated in the flowchart of FIG. 12.

FIG. 12 illustrates a process for executing an intermediate code according to embodiment 2 of the present invention. The process shown in FIG. 12 is substantially the same as that shown in FIG. 9, except that step 1201 of FIG. 12 differs slightly from step 902 of FIG. 9. An operation performed at step 1201 of FIG. 12 is the same as an operation which is performed at step 902 of FIG. 9 except that decryption of a cipher is not performed, i.e., an operation which is performed at step 802 of FIG. 8 when the encryption flag indicates that the intermediate code is not encrypted. The operations of the other steps in FIG. 12 are the same as those in FIG. 9. Thus, like elements are indicated by like reference numerals used in FIG. 9, and detailed descriptions thereof are omitted.

An LSI of the present invention can be used to construct an information recording apparatus, an information reproducing apparatus, and an information recording/reproducing apparatus. In these apparatuses, an operation of the LSI incorporated therein can be modified by rewriting an intermediate code according to the purpose of the apparatus. Thus, the standards and specifications of these apparatuses can be readily customized.

Furthermore, since the above RAM includes an externally-accessible RAM region and an externally-inaccessible RAM region, the amount of calculations for an encrypted intermediate code does not affect the execution time for the intermediate code. Therefore, a complicated algorithm can be used for encryption/decryption of the intermediate code.

In an LSI according to the present invention, a RAM for storing an intermediate code, a ROM for storing an interpreter execution program capable of interpreting the intermediate code, and a CPU for controlling execution of the interpreter execution program are formed on one chip. With such a structure, there is no concern of leakage of the contents of the interpreter execution program stored in the ROM outside of the chip during the operation of the CPU. Further, there is no possibility that transmission of signals between the CPU and the RAM and ROM is observed by a third party.

Furthermore, an optical disc apparatus of the present invention has an execution section for executing an interpreter execution program, which is capable of interpreting an intermediate code, so as to generate a control command string. With such a structure, the optical disc apparatus of the present invention can be modified only by rewriting the intermediate code so as to be compatible with various disc apparatuses from a plurality of manufacturers which are designed based on different standards or specifications. Furthermore, even when a necessity of modifying specifications or adding functions arises in the process of development of a disc apparatus, such necessity can be readily satisfied only by rewriting an intermediate code without adding additional circuitry to the LSI or exchanging the LSI itself with another one.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. An LSI, comprising:
a RAM for storing an intermediate code;
a ROM for storing an interpreter execution program that is capable of interpreting the intermediate code; and
a CPU for controlling execution of the interpreter execution program,
wherein the RAM, the ROM, and the CPU are formed on one chip.

2. An LSI according to claim 1, wherein the intermediate code is encrypted.

3. An LSI according to claim 1, wherein:
the RAM can store an encrypted intermediate code and an unencrypted intermediate code; and
the interpreter execution program can interpret both the encrypted intermediate code and the unencrypted intermediate code.

4. An LSI according to claim 1, further comprising:
a recording/reproduction head for recording/reproducing information on an optical disc; and
an optical disc control section for controlling a motor which drives the optical disc,
wherein the optical disc control section is formed on the one chip.

5. An optical disc apparatus, comprising:
an execution section for executing an interpreter execution program that is capable of interpreting an intermediate code, so as to generate a control command string; and
a control section for controlling recording/reproduction of information on an optical disc according to the control command string.

6. An optical disc apparatus according to claim 5, wherein the execution section includes:
a RAM for storing an intermediate code;
a ROM for storing the interpreter execution program; and
a CPU for controlling execution of the interpreter execution program.

7. An optical disc apparatus according to claim 6, wherein the RAM, the ROM, and the CPU are formed on one chip.

8. An optical disc apparatus according to claim 7, wherein the control section includes:
a recording/reproduction head for recording/reproducing information on the optical disc:
a motor for driving the optical disc; and
an optical disc control section for controlling the recording/reproduction head and the motor.

9. An optical disc apparatus according to claim 8, wherein the optical disc control section is formed on the one chip.

10. An optical disc apparatus according to claim 5, wherein the intermediate code is encrypted.

11. An optical disc apparatus according to claim 6, wherein:
the RAM can store an encrypted intermediate code and an unencrypted intermediate code; and
the interpreter execution program can interpret both the encrypted intermediate code and the unencrypted intermediate code.
